(19) United States
(12) Patent Application Publication
(10) Pub. No.: US 2014/0143576 A1
(43) Pub. Date: May 22, 2014

(54) ENERGY SAVING NETWORK APPARATUS AND SYSTEM

(71) Applicant: GEMTEK TECHNOLOGY CO., LTD., Hsinchu (TW)

(72) Inventors: Chin Wen Chang, Hsinchu (TW); Yung Chang Lin, Hsinchu (TW); Chung Cheng Hsieh, Hsinchu (TW); Ping Chen Li, Hsinchu (TW)

(73) Assignee: GEMTEK TECHNOLOGY CO., LTD., Hsinchu (TW)

(21) Appl. No.: 13/893,857

(22) Filed: May 14, 2013

(30) Foreign Application Priority Data
Nov. 22, 2012 (TW) 101143623

(51) Int. Cl. G06F 1/32

(52) U.S. Cl. CPC G06F 1/3231
USPC 713/324

(57) ABSTRACT

An energy saving network apparatus comprises: a network apparatus including a plurality of beacons and a display unit; a portable identification apparatus including an identification code and token by a user; a access control apparatus used to control the user to approach the network apparatus, the access control apparatus including an identification reader used to read the identification code of the portable identification apparatus and transmit an identification signal including the identification code; and a server used to receive the identification signal and identify the identification code and send a signal to the access control apparatus and the network apparatus for controlling the access control apparatus, the beacons and the display unit to be powered on or off, whereby the beacons and the display unit are powered off so as to achieve power saving for the energy saving network system.

### CROSS-REFERENCE TO RELATED APPLICATION

This application claims priority from Taiwan Patent Application No. 101143623 filed on Nov. 22, 2012, which is hereby incorporated herein by reference in its entirety.

### BACKGROUND OF THE INVENTION

1. Field of the Invention

The present invention relates to an energy saving network apparatus and a system using the same, and more particularly to an apparatus with control status beacons and a display unit capable of saving energy.

2. Description of Related Art

Traditional network apparatuses have beacons and displays which are only used to show the information of the data package delivery or other processes so that the network keepers can see the operation statuses on them in order to further maintain the apparatuses. After the network keeper maintains such an apparatus, in the traditional design, the beacons still emit light and the display continues to show information on its screen. Therefore, much excess power is wasted for such useless lighting. Even though the beacons and the display are not high power-consumption devices, wasted power is noticeable and accumulated over a long term. That is, they are turned on all day long and nobody intends to see them most of the time.

### SUMMARY OF THE INVENTION

The aspect of the application is to provide an energy saving network apparatus. It can be combined with an identification control apparatus and a server to have an energy saving network system.

According the foregoing aspect, the application provides an energy saving network apparatus comprising: a plurality of beacons and a display unit for showing the operation information of the apparatus such as a connection status, data transmission, transmitting speed, temperature, connection analyses and the like; a control unit for controlling the beacons and the display unit to be turned on or off, whereby the beacons and the display unit are powered off so as to achieve power saving for the energy saving network apparatus.

According the foregoing aspect, the application provides an energy saving network apparatus comprising: a network apparatus including a plurality of beacons and a display unit; a portable identification apparatus including an identification code and token by a user; a access control apparatus used to control the user to approach the network apparatus, the access control apparatus including an identification reader used to read the identification code of the portable identification apparatus and transmit an identification signal including the identification code; and a server used to receive the identification signal and identify the identification code and send a signal to the access control apparatus and the network apparatus for controlling the access control apparatus, the beacons and the display unit to be powered on or off, whereby the beacons and the display unit are powered off so as to achieve power saving for the energy saving network system.

### DESCRIPTION OF THE DRAWINGS

The various advantages of the embodiments of the present invention will become apparent to one skilled in the art by reading the following specification and appended claims, and by referencing the following drawings, in which:

FIG. 1 is a schematic diagram of an energy saving network apparatus according to the present application;

FIG. 2a is a schematic diagram of an energy saving network system according to an embodiment of the present application;

FIG. 2b is a schematic diagram of an energy saving network system according to another embodiment of the present application;

FIG. 3a is a schematic diagram of an energy saving network system according to another embodiment of the present application; and

FIG. 3b is a schematic diagram of an energy saving network system according to another embodiment of the present application.

### DETAILED DESCRIPTION OF THE INVENTION

The following detailed description refers to the accompanying drawings that show, by way of illustration, specific details and embodiments in which the invention may be practiced. Any embodiment or design described herein as exemplary is not necessarily to be construed as preferred or advantageous over other embodiments or designs.

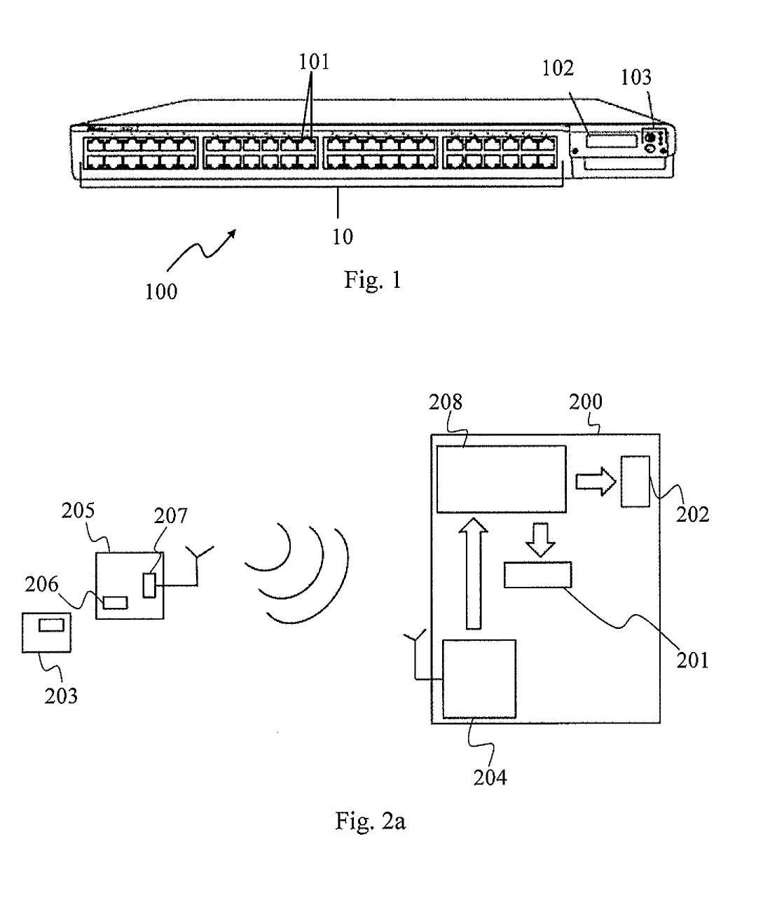

FIG. 1 is a schematic diagram of an energy saving network apparatus according to the present application. The energy saving network apparatus 100 comprises forty-eight network ports 10 and/or a display unit 102, wherein each of the network ports 10 is associated with two beacons 101 for showing the operation information of the apparatus 100 such as a connection status, data transmission, transmitting speed, temperature, connection analyses and the like; and a button acting as a control unit 103, wherein the network apparatus 100 includes a CPU (central processor unit; not shown) and the CPU controls the beacons 101 and/or the display unit 102 to be turned on or off according the switching signals of the control unit 103.

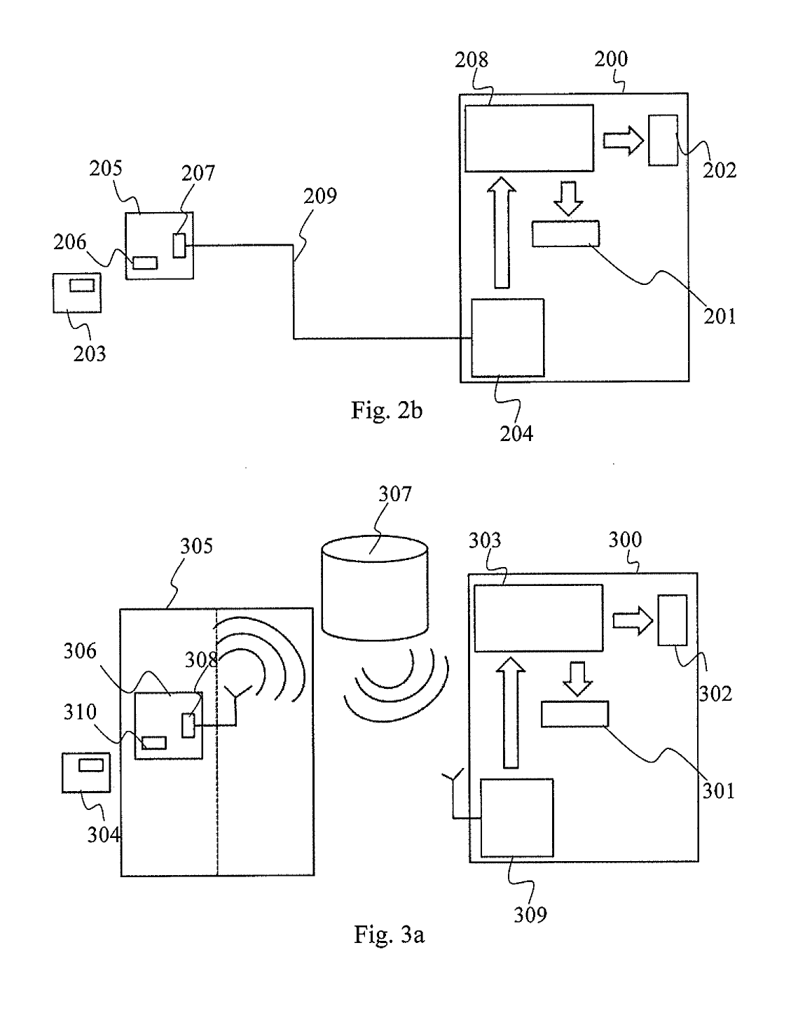

FIGS. 2a and 2b are schematic diagrams of an energy saving network system according to an embodiment of the present application. Each of the network system comprises: a portable identification apparatus 203 including an identification code and token by a user; an identification reader 205 being an RFID (radio frequency identification) apparatus, wherein the identification reader 205 includes a reader unit 206 being an FR reader for reading the identification code of the portable identification apparatus 203 and a signal transmission unit 207 for transmitting an identification signal including the identification code; a network apparatus 200 comprising a signal receiver 204 for receiving the identification signal; a plurality of beacons 201 and/or a display unit 202; and a CPU 208 controlling the beacons 201 and/or the display unit 202 to be turned on or off according the identification signal.

Referring to FIG. 2a, it shows another embodiment of the application. The identification reader 205 and the signal receiver 204 transmit the identification signal via wireless communication.

Referring to FIG. 2b, it shows another embodiment of the application. The identification reader 205 and the signal receiver 204 transmit the identification signal via wire communication (or a cable line) 209.

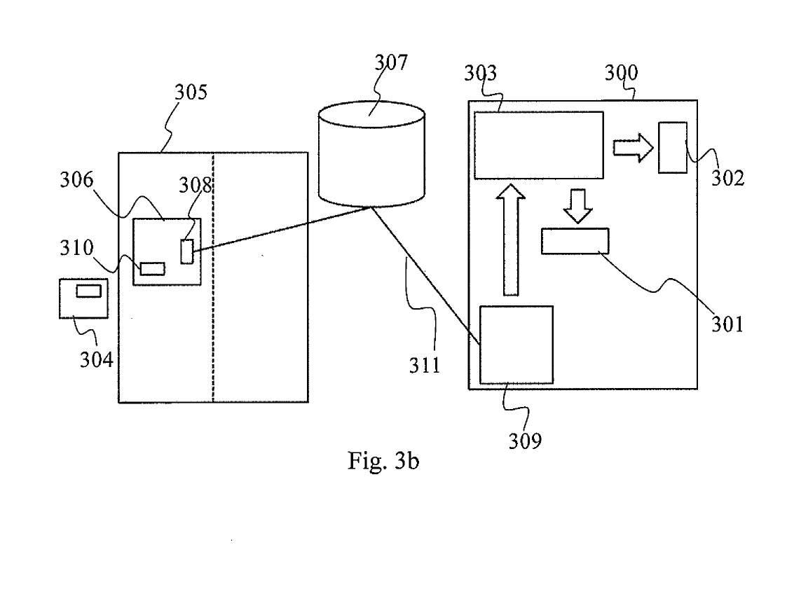

FIGS. 3a and 3b show energy saving network systems according to another two embodiments of the present application. Each of the network system comprises: a network apparatus 300 including a plurality of beacons 301 and/or a display unit 302; a CPU 303; a portable identification apparatus 304 being an RFID (radio frequency identification) apparatus and including an identification code, wherein the portable identification apparatus 304 is taken by a user; an access control apparatus 305 used to control the user to approach the network apparatus 300, wherein the access control apparatus 305 includes an identification reader 306 being a RF reader and having a reader unit 310 used to read the identification code of the portable identification apparatus 304 and transmits an identification signal including the identification code via a signal transceiver 308; and a server 307 capable of transmitting and receiving signals, wherein the server 307 is used to receive the identification signal and identify the identification code and send a signal to the signal transceiver 308 for controlling the access control apparatus 305 and a signal to a signal receiver 309 of the network apparatus 300 and the CPU 303 controls the beacons 301 and/or the display unit 302 to be powered on or off according to the signals from the server 307. The server 307 can communicate with the identification reader 306 and the network apparatus 300 through wireless communication (as shown in FIG. 3a) or wire communication (as shown in FIG. 3b). FIG. 3b shows an interne connection 311.

TABLE 1
Power consumption (kW · h) of the LEDs (light emitting
diodes) of the network switcher with mode
no. RTM-291 manufactured by the applicant.

| | LEDs' | LEDs' Power | LEDs' Power | LEDs' Power |
|---|---|---|---|---|
| | Power | consumption | consumption | consumption |
| | consumption | per day | per | per |
| | (W) | (kW · h) | month (kW · h) | year (kW · h) |
| 1 set with | 1.782 | 0.0427 | 1.281 | 15.372 |
| 24 ports | | | | |
| 1 sets with | 3.564 | 0.0854 | 2.562 | 30.744 |
| 24 ports | | | | |
| 10 sets, | 17.82 | 0.427 | 12.81 | 153.72 |
| each with | | | | |
| 24 ports | | | | |
| 10 sets, | 35.64 | 0.854 | 25.62 | 307.44 |
| each with | | | | |
| 48 ports | | | | |

TABLE 2
Percentage of power saving of the network switcher with
mode no. SF200-24P manufactured by Cisco, based on the
LEDs with limited current 10 mA used therein.

| | Current | Switcher's | | Percentage |
|---|---|---|---|---|
| AC | required | power | LEDs' | of power |
| Voltage | by | consumption | power | saving |
| (V) | switcher (A) | (W) | consumption | (% ) |
| 110 | 0.346 | 21.3 | 1.584 | 7.48 |
| 220 | 0.166 | 22.2 | 1.584 | 7.13 |

In view of above tables 1 and 2, the application certainly provides a better network apparatus with high energy saving. The energy saving network apparatus combines an identification control apparatus and a server to avoid power consumption caused by useless lighting and display.

The disclosure and discussion set forth herein is illustrative and not intended to limit the practice of the instant invention. While there have been described what are believed to be the preferred embodiments of the instant invention, those skilled in the art will recognize that other and further changes and modifications may be made thereto without departing from the spirit of the invention, and it is intended to claim all such changes and modifications that fall within the full scope of the invention.

What is claimed is:

1. An energy saving network system comprising:
a network apparatus including a plurality of beacons and a display unit;
a portable identification apparatus including an identification code and token by a user;
an access control apparatus configured to control the user to approach the network apparatus, the access control apparatus including an identification reader configured to read the identification code of the portable identification apparatus and transmit an identification signal including the identification code; and
a server configured to receive the identification signal and identify the identification code and send a signal to the access control apparatus and the network apparatus for controlling the access control apparatus, the beacons and the display unit to be powered on or off.

2. The energy saving network apparatus of claim 1, wherein the server communicates with the identification reader and the network apparatus through wireless or wire connection.

3. The energy saving network apparatus of claim 2, wherein the network apparatus includes a CPU (central processor unit) controlling the beacons and the display unit to be turned on or off according to signals from the server.

4. The energy saving network apparatus of claim 3, wherein the portable identification apparatus is an RFID (radio frequency identification) apparatus and the identification reader is a radio frequency reader.

5. An energy saving network system comprising:
a portable identification apparatus including an identification code and token by a user;
an identification reader including a reader unit and a signal transmission unit, the reader unit configured to read the identification code of the portable identification apparatus, the signal transmission unit transmitting an identification signal including the identification code;
a network apparatus including:
a wireless signal receiver configured to receive the identification signal; and
a plurality of beacons and a display unit turned on or off according to the identification signal.

6. The energy saving network system of claim 5, wherein the network apparatus includes a CPU controlling the beacons and the display unit to be turned on or off according to the identification signal.

7. The energy saving network system of claim 5, wherein the portable identification apparatus is an RFID apparatus and the identification reader is a radio frequency reader.

8. An energy saving network apparatus comprising:
a plurality of beacons and a display unit; and
a signal receiver configured to receive an identification signal from an exterior of the energy saving network apparatus, wherein the beacons and a display unit are turned on or off according to the identification signal.

9. The energy saving network apparatus of claim 8, wherein the signal receiver receives the identification signal through wireless or wire connection.

10. The energy saving network apparatus of claim 8, further comprising a CPU controlling the beacons and the display unit to be turned on or off according to the identification signal.
